(19) United States
(12) Patent Application Publication
(10) Pub. No.: US 2010/0030696 A1
(43) Pub. Date: Feb. 4, 2010

(54) BIOMETRIC ELECTRONIC PAYMENT TERMINAL AND TRANSACTION METHOD

(76) Inventor: David Naccache, Paris (FR)

Correspondence Address: WESTMAN CHAMPLIN & KELLY, P.A., SUITE 1400, 900 SECOND AVENUE SOUTH, MINNEAPOLIS, MN, 55402, US

(21) Appl. No.: 12/438,539

(22) PCT Filed: Aug. 17, 2007
(86) PCT No.: PCT/FR2007/001381

§ 371 Date: Apr. 22, 2009

(30) Foreign Application Priority Data
Aug. 22, 2006 (FR) 0607440

(51) Int. Cl. G06Q 40/00; G06Q 20/00; H04L 9/32; G06K 9/00; H04L 9/00

(52) U.S. Cl. 705/71; 705/44; 382/117; 380/277

(57) ABSTRACT

An electronic payment terminal includes a device for acquiring biometric data and a program capable of: acquiring biometric data during a transaction by a biometric data acquisition device; and storing the biometric data in the payment terminal. A corresponding transaction method is also provided.

### CROSS-REFERENCE TO RELATED APPLICATIONS

This Application is a Section 371 National Stage Application of International Application No. PCT/FR07/001381, filed Aug. 17, 2007 and published as WO 2008/023114 on Feb. 28, 2008, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

This disclosure relates to an electronic payment terminal. The disclosure likewise relates to a corresponding transaction method.

### BACKGROUND OF THE DISCLOSURE

An electronic payment terminal (EPT) is an electronic device enabling a secure electronic transaction to be recorded. An EPT is typically a computer located at a retail establishment, which enables bank card payments (such as smart cards or magnetic strip cards). The merchant inserts the client card into the reader of the terminal and enters the amount of the transaction. The client validates their purchase, e.g., by entering their personal identification number on the keyboard of the device, and receives a receipt confirming the transaction.

Some EPTs are portable; in particular, they include a smart card reader, receipt printing means, a modem, and a GSM card. They are used, in particular, in taxis, marketplaces and for home delivery.

At retail establishments, these EPTs are often connected to management means (e.g., a cash register) which enables point-of-sale management. The EPT/management means comprises a point-of-sale terminal (POS terminal). Some POS terminals comprise a handheld part for reading smart cards and printing receipts. This part rests on a base when not in use, and, when in use, communicates with this base via a wireless connection, e.g., radio relay link. The base can be connected to the management means; it typically includes a modem enabling payment authorisations to be obtained from authorised institutions.

Although the EPT payment system has a high level of security, owing to the identification of the bank smart and/or magnetic strip bank card, to the possible use of a user code (PIN code) and to the possible use of a signature, fraud is still possible in the case of bank card theft and PIN code theft, for example. It is therefore desirable to further improve the level of security by making fraud more dissuasive, and to possibly enable subsequent verification of the identity of the user at the origin of the transaction.

These problems occur in similar terms for other electronic terminals, such as automated teller machines, for example.

Consequently, the purpose of an embodiment of present the invention is to design terminals equipped with a fraud-deterrent system.

### SUMMARY

Thus, one aspect of the present disclosure is directed to an electronic payment terminal comprising a biometric data acquisition device and a program capable of:
acquiring biometric data during a transaction, by means of the biometric data acquisition device; and
storing the biometric data in the payment terminal.

In one embodiment, the invention includes one or more of the following characteristics:
the program is further capable of requesting authorisation to validate the transaction from a central office and, where appropriate, of receiving from the central office authorisation to validate the transaction and of validating the transaction;
the program is further capable of storing the biometric data in the terminal permanently or for a predetermined time period, and of providing the stored biometric data, if need be for the predetermined time period, and preferably under the condition that certain security conditions are satisfied;
the program is further capable of providing biometric data to the central office before requesting authorisation to validate the transaction or simultaneously;
the program is further capable of receiving biometric reference data from the central office, of establishing a comparison between the acquired biometric data and the reference biometric data, and of validating or not validating the transaction based on the result of the comparison;
the program is further capable of establishing a comparison between the biometric data and standard data, and, where appropriate, on the basis of the result of the comparison, of not validating the transaction and of acquiring new biometric data by means of the biometric data acquisition device;
the program is further capable of establishing the comparison between the biometric data and the reference biometric data and/or the comparison between the biometric data and the standard data via pattern recognition;
the electronic payment terminal according to an embodiment of the invention further includes means of inputting a code by a user, and the program is configured such that, for the user, the biometric data acquisition device serves as means of validating the code input;
the biometric data acquisition device is selected from the group comprising photographic cameras enabling the capture of stationary or moving images, fingerprint sensors, iris recognition sensors; and
the program is further capable of encrypting biometric data within the terminal, using a public key probabilistic encryption algorithm, the public key belonging to one of the following entities: the bank, the card owner, a trusted third party or the manufacturer of the terminal.

An embodiment of the invention likewise relates to a transaction method comprising the acquisition of biometric data by an electronic payment terminal during a transaction, and storage of the biometric data in the payment terminal. According to an alternative, this method is implemented with the electronic payment terminal according to an embodiment of the invention. According to another alternative, this method further includes a step of validating the transaction irrespectively of the stored biometric data.

### BRIEF DESCRIPTION OF THE DRAWINGS

Other characteristics and advantages will become apparent upon reading the following detailed description of embodiments of the invention, given for illustrative purposes only and the appended drawings of which:

FIG. 1 is a block diagram of an electronic payment terminal according to an illustrating example of the disclosure.

FIG. 2 is a flow chart illustrating a transaction method according to an example of the disclosure.

### DETAILED DESCRIPTION OF ILLUSTRATIVE EMBODIMENTS

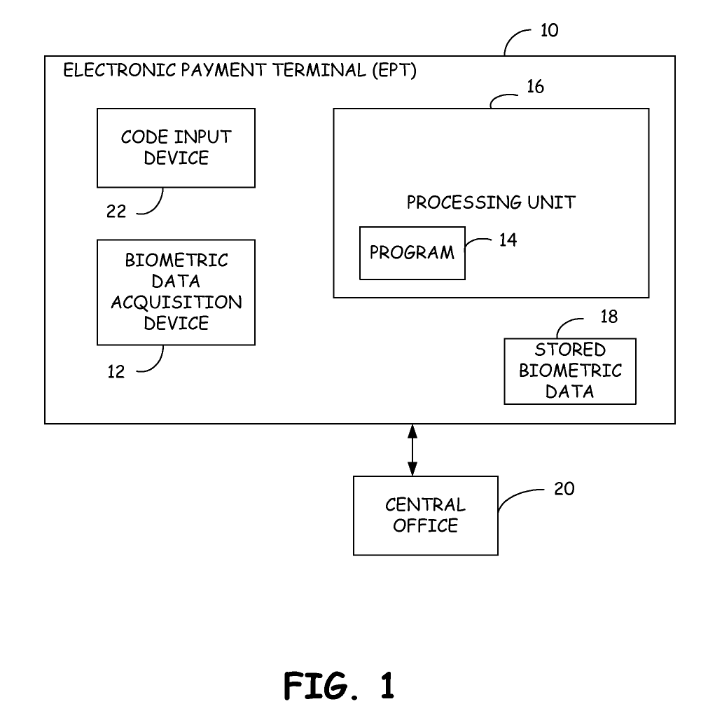

In the remainder of the description, an electronic payment terminal (EPT) 10, as shown in FIG. 1, is taken as an example of an electronic terminal according to an embodiment of the invention. This embodiment is advantageous because it is desirable to improve the confidence of users (clients or merchants) in the EPT payment system. Furthermore, the application of an embodiment of the invention to an EPT becomes all the more advantageous the greater the number of transactions carried out by the EPTs.

An embodiment of the invention proposes an EPT comprising a biometric data acquisition device 12.

Biometric data is understood to mean data relating to the physical characteristics of human persons. For example, the biometric data can relate to fingerprints, the shape of the face, the shape of the eye's iris, an ordinary photograph or the like.

In this regard, it is important to note that the biometric data involved in an embodiment of the present invention does not necessarily have to be data that can be analyzed or understood by a machine, but can be data the analysis or recognition of which requires human intervention (e.g., a photograph), or that of a human expert. Human intervention may prove to be easier to implement, insofar as it is only required a posteriori, e.g., in the case of proven fraud (i.e., relatively rarely).

The biometric data acquisition device 12 can be any biometric data sensor, e.g., a fingerprint sensor or a photographic camera or else a combination of various sensors and/or photographic cameras. Specific image acquisition devices (applied to the face or fingerprints), iris data, and voice-recording devices are known. Fingerprint acquisition is particularly well-suited to payment terminals because it does not disrupt the habits of the user, who is accustomed to using their fingers with a terminal. It is further possible to anticipate the acquisition of digital images by means of devices similar to those commonly found today in mobile phones or inexpensive surveillance cameras. Therefore, biometric data is likewise understood to mean a film taken by the EPT, e.g., in MPEG format.

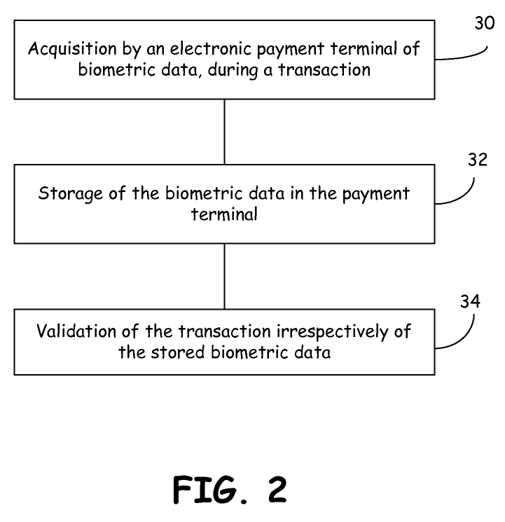

The EPT 10 likewise includes a program 14, which is stored in the processing unit 16 of the terminal. This program 14, for example, forms part of the EPT operating system or is added-on (installed) over the operating system. The program is capable of acquiring (step 30 of FIG. 2) biometric data during a transaction, i.e., of implementing the biometric data acquisition device 12, as well as storing (step 32 of FIG. 2) the biometric data after acquisition. The storage 18 can be temporary (in the random access memory) or long-term, or even permanent, depending on the embodiments.

A transaction is understood to mean a data modification operation, typically in one or more data bases and devices. This modification, for example, can be made offline (in the card and/or EPT alone), online (at the central office level), or in mixed mode. In the case of the EPT, the transaction is a payment.

According to a preferred embodiment, validation of the transaction (step 34 of FIG. 2) is not subject to any control by the EPT (and possibly the central office) of the biometric data acquired prior to the transaction. In this way, it is possible for a user to lend their bank card to a spouse or friend, for example, without any risk of blocking the transaction.

The EPT 10 is preferably connected to a central office 20 via means of communicating with the central office. The program 14, for example, can be capable of requesting a transaction validation authorisation from the central office. This request is accompanied by the transmission of data to the central office. In particular, in the case of a payment transaction, the data can include data relating to the merchant, to the identification of the bank account of the user-payer and data relating to sum of money which is the object of the transaction. Once this data has been processed by the central office, the central office transmits a validation authorisation or non-authorisation for the transaction to the EPT. The EPT program is then capable of possibly receiving the validation authorisation or non-authorisation for the transaction and of validating the transaction, in the event of receiving a validation authorisation (or of not validating the transaction in the event of failing to receive a validation authorisation or in the event of receiving a validation non-authorisation). For further details, reference can be made, for example, to the “Electronic Payment Manual” and to the “Transmission Protocol with Processing and Authorisation Centres” published by the “CB Economic Interest Group.

According to one particular embodiment, the program is capable of storing the acquired biometric data in the EPT on a long-term basis. This storage 18 can be carried out in a random access memory block the content of which is maintained by a battery or in a flash memory, hard disk, etc. This storage can be ensured permanently or for a predetermined time period, based on the configuration of the program. This time period, for example, can be a week, a month or a year. The program is optionally capable of deleting the biometric data once the predetermined time period has elapsed, or else according to a first in-first out principle.

The program 14 can be further capable of supplying the stored biometric data upon request, during the storage period. Obviously, supplying biometric data in this way would typically be subject to the satisfaction of certain security conditions such as the presentation of a PIN code or the insertion of an “administrator card” into the terminal. In this way, the stored biometric data is available, for example, to the police and the justice system, if an objection is raised as to the identity of the user of the EPT (in this case the payer), or if fraud is proven after the transaction. Use of the stored biometric data makes it possible to verify whether the user was or was not a person authorised to conduct the transaction, and possibly enables a defrauder to be tracked down, or even to determine the identity of the unauthorised user. It should be noted that, if so desired, this embodiment makes it possible to ensure that validation of the transaction is carried out irrespectively of the biometric data acquired. In this case, the biometric data is acquired during the transaction but is not involved in the transaction validation process, as it simply remains available for subsequent use, in the event of a problem. By minimising the opportunities for actual use of the biometric data, this embodiment offers specific guarantees, in terms of privacy and individual freedom.

According to another embodiment, the program is capable of supplying the acquired biometric data to a central office. In this case, it is possible to provide for the EPT to store the biometric data only temporarily and to then delete it. The biometric data, for example, can be maintained at the central office level, with a view to subsequent use in a manner similar to that described above. In exceptional cases, the biometric data can likewise be processed by the central office so as to identify the user of the EPT, e.g., in the event of a doubt or particular risk concerning the transaction (e.g., a large amount or a purchase made in a distant country). In this case, the result of analyzing the biometric data, possibly in addition to that of other data such as a PIN code or data specific to the payment method (bank card), partially conditions the transmission or non-transmission by the central office of a transaction validation authorisation or non-authorisation.

Analysis of the biometric data, for example, consists in comparing the biometric data to reference biometric data, e.g., associated with the authorised user(s) of the payment method. There is a formal identification of the user prior to the transaction (but preferably in exceptional cases only), which makes fraud (and dispute) impossible or extremely difficult. Since such specific cases of risk normally ought to be rather rare, implementation of the system does not require heavy calculations, and does not slow down the fluidity of cash operations. This proves to be all the more advantageous as the number of clients passing through per hour increases.

According to an alternative, and still (preferably) in the event of a particular risk to the transaction, the comparison of the biometric data with the reference biometric data can be carried out at the EPT level. In this case, the central office, for example, supplies the EPT with the reference biometric data (associated with the payment method used in the requested transaction). This reference data may alternatively be read directly from the bank card or the SIM of the user. Alternatively, this reference data may be derived from any trustworthy storage source, including the EPT memory itself. The EPT does or does not validate the transaction, based on the result of this comparison, i.e., the transaction is validated if the acquired biometric data is deemed to be consistent with the reference biometric data.

According to one alternative, after validation of the transaction, it is possible to provide for the deletion of the biometric data and reference biometric data at the terminal level, so as to ensure the confidentiality of the biometric data.

In the above-described embodiments, analysis of the biometric data can involve automated pattern recognition (e.g., recognition of fingerprint, iris or facial pattern), or human pattern recognition (viewing of the real-time photograph by a bank employee knowing the legitimate user of the card), in which cases the reference biometric data is representative of a fingerprint, iris or facial pattern of one or more authorised users associated with the payment method.

According to one particular embodiment, the program is likewise capable of ensuring that the acquired data is indeed usable. To do so, it establishes a comparison between the biometric data and the standard data (possibly via pattern recognition). In this way, if need be, the program can be configured so as to not validate the transaction and to request and acquire new biometric data, based on the usability thereof, by means of the biometric data acquisition device. In other words, the program is capable of verifying whether the acquired data does indeed have the characteristic pattern required for the use thereof. For example, if the biometric data corresponds to a fingerprint, the program is capable of searching the image obtained during data acquisition for the typical characteristics of any fingerprint, in order to verify whether the acquired biometric data corresponding to the finger print is usable. If this is not the case, e.g., because the user is wearing a glove, then, depending on the adopted configuration, the program does not validate the transaction or is capable of acquiring new biometric data (e.g., after the request in this case). The procedure can be repeated, if the new biometric data is still not satisfactory. The same procedure can be applied in the case of recognition of the pattern of a face or the pattern of an iris, in order to prevent an image from being processed wherein the face or iris of the user does not appear correctly. In this way, it can be made impossible for the user of the EPT to eliminate themselves from the acquisition of biometric data capable of being used to conduct the transaction

In this way, for example, data structures {T, B } might be retained for subsequent auditing, wherein T is the reference for the transaction (e.g., the transaction number) and B is the biometric data acquired during the transaction. Therefore, it is possible to enhance the data structures backed-up in the EPT with additional fields, which are not uploaded to the central office but backed up so as to facilitate a subsequent inquiry. Additional data such as this (referenced as D and generalising the data structures {T, B} as {T, B, D}) is, for example, a photograph of the item purchased, an electronic copy of the contents of the cash register receipt, the identity of the cashier having carried out the sale and of potentially being capable of later providing testimony, etc.).

On particularly advantageous and natural method of encoding might consist in encoding the image of the fingerprint in a graphic file named T.jpg. In this way, the information B is the file T.jpg and there is no need to create an actual data base.

Therefore, in the case where the date might be uploaded to the central office, it should be noted that the transmission of T and B (or {B, D}) may not have to take place at the same time. Thus, T can be transmitted in real time whereas all of B (or {B, D}) accumulated during the day might be uploaded to the central office overnight. This makes it possible to shorten the transaction time.

Finally, it should be noted that the transaction can be conducted concurrently (simultaneously) with the capture of the biometric information. This makes it possible to optimise the check-out time.

Furthermore, archiving of the biometric data can be conditional upon preliminary agreement by the legitimate user. In this embodiment, during obtainment of the payment method (typically a credit card), the user freely chooses to associate (or not associate) a biometric backup with their card. In this way, when an EPT enters into contact with the card, it contacts the central office which, before validating the transaction, consults the data base thereof in order to determine if the user has or has not concurred with the biometric backup. If so, the central office gives notice of this to the terminal, which will not validate the transaction before having acquired and backed up a fingerprint. Alternatively, the information used from a biometric backup can be encoded in the card. In this case, in order to prevent clone cards, which might routinely go on record as not requiring any biometric backup, a digital signature-based cryptographic protocol can be implemented between the card and the terminal. Typically, the EPT might send a challenge r to the card and request the card to return thereto a valid digital signature over the channel (r | “no biometric backup required), wherein the operator “|” designates the concatenation. The implementation of such protocols being known by those skilled in the art.

Generally speaking, the backing up of biometric data will preferably be carried out while respecting the confidentiality thereof.

In order to accomplish this, one particularly advantageous method consists in encrypting the data on-board the terminal by means of a public key probabilistic encryption algorithm of which only the public key is contained in the terminal. For example, the RSA OAEP algorithm. In this way, even in the event that the terminal is tampered with, the biometric data remains confidential, because the terminal does not contain any secret and can only encrypt the biometric information, without necessarily having the ability to decipher it. Several embodiments are possible, as concerns the entity whose public key is used for this encryption. This entity can be the user's bank, a trusted third party or even the user themselves. It stands to reason that, regardless of who this entity might be, the public key thereof must depend on a series of certificates that are valid prior to being accepted by the EPT.

Furthermore, an EPT generally includes means 22 of inputting a code by a user (user code or PIN code), as well as means of validating the code input. In practice, the code inputting means include a numeric or alphanumeric keypad and the code input validation means generally consist of a “validation” key which is intended to be pressed by the user once that they have input their code. Pressing this key indicates to the EPT that the code has been input. The EPT according to an embodiment of the invention can have such features. In this case, the biometric data acquisition device is separate from the code inputting means and code input validation means. The program is then capable of recording the code input and of proceeding with validation of the code by the user, and of then acquiring biometric data or, conversely, of acquiring biometric data and of then inputting the code and validating the code by the user.

However, according to another embodiment, the biometric data acquisition device serves as code input validation means. Thus, the EPT does not include any “validation” key, the latter being replaced by the biometric data acquisition device. The program is then configured such that the user is called upon to input their code, and to then lend itself to acquiring biometric data, which also validates the code that was input.

An example of an EPT lending itself to the implementation of an embodiment of the invention will now be described.

This EPT is equipped with a GSM/GPRS (900/1800 or 900/1900 MHZ dual-band) communication module. In the event of a malfunction on the GSM/GPRS network, an optional modem can, if need be, ensure continuous operation.

The EPT is, for example, equipped with a 32-bit processor assuming the usual cryptographic systems (RSA, DES, triple DES . . . ). The architecture of the process is preferably chosen so as to enable several applications to operate independently of the other applications provided for in the EPT, so as to ensure software security (or software tightness).

One particularly suitable platform for implementing an embodiment of the invention is adapted from the UNICAPT 32 platform by Igenico, which is built around a 32-bit processor (HSC module hardware, for “High Security Core”), including embedded security and a multi-application operating system supporting advanced programming languages such as C, C++ or JAVA. A platform such as this is integrated into numerous environments:
roaming use with a GPRS mobile phone or Bluetooth;
multi-check-out environments using Ethernet or Wi-Fi with TCP/IP;
High sales volume merchants using ADSL;
External communication via USB/PCMCIA;
Internet connection via Wi-Fi access points.

This platform can be modified (in particular the configuration program thereof) so as to enable implementation of the characteristics according to an embodiment of the invention.

However, embodiments of the invention are not limited to the alternatives described hereinabove, but is susceptible of numerous other alternatives easily accessible to a person skilled in the art. To illustrate, it is possible to anticipate applications of an embodiment of the invention to stationary, handheld and mobile ETPs. In the same way, the preceding description can also be read by replacing the EPT with a business telephone, a business photocopier or any device wherein control of the posterior usage might discourage fraud, ill-advised use or abuse. It is obviously appropriate to bear in mind that the storage of biometric data in the device is preferably carried out irrespectively of the transaction (or of any operation permitted by this device, e.g., a telephone call or a photocopy), and that monitoring of the stored biometric data is optionally carried out a posteriori. Consequently, the confidentiality of this data is preserved and this data is used only upon specific request, e.g., with the consent of the user. In this case, abuse or fraud is-is discouraged a posteriori. As a further illustration, it is possible to anticipate an embodiment wherein biometric data stored on a bank card serves as reference or standard data. Furthermore, any physical characteristic, such as the face, voice, iris, retina, thumb, shape of the hand and ear, and DNA can be the subject of biometric measurements for the purposes of applying an embodiment of the invention. By extension, it is possible to anticipate the use of behavioural characteristics as the signature or manner of typing on a keyboard.

Although the present disclosure has been described with reference to one or more examples, workers skilled in the art will recognize that changes may be made in form and detail without departing from the scope of the disclosure and/or the appended claims.

1. An electronic payment terminal comprising:
a biometric data acquisition device,
means for inputting a code by a user, and
a program capable of:
acquiring biometric data during a transaction, by the biometric data acquisition device; and
storing the biometric data in the payment terminal, the electronic payment terminal being capable of validating the transaction irrespectively of the stored biometric data and said program being configured such that, for the user, said biometric data acquisition device validates the inputting of said code.

2. The electronic payment terminal according to claim 1, wherein the program is further capable of:
requesting authorisation to validate the transaction from a central office, and
where appropriate, receiving from the central office authorisation to validate the transaction and of validating the transaction.

3. The electronic payment terminal according to claim 1, wherein the program is further capable of:
storing the biometric data in the terminal permanently or for a predetermined time period,
providing the stored biometric data, if need be, for the predetermined time period, and under a condition that certain security conditions are satisfied.

4. The electronic payment terminal according to claim 2, wherein the program is further capable of:
supplying the biometric data to the central office prior to or simultaneous with the request for authorisation to validate the transaction.

5. The electronic payment terminal according to claim 1, wherein the program is further capable of establishing a comparison between the biometric data and standard data.

6. The electronic payment terminal according to claim 5, wherein the program is further capable of:
establishing a comparison between the biometric data and reference biometric data and/or the comparison between the biometric data and the standard data via pattern recognition.

7. (canceled)

8. The electronic payment terminal according to claim 1, wherein the biometric data acquisition device is selected from the group comprising photographic cameras enabling capture of stationary or moving images, fingerprint sensors and iris recognition sensors.

9. The electronic payment terminal according to claim 1, wherein the program is further capable of encrypting biometric data within the terminal, using a public key probabilistic encryption algorithm, and a public key belonging to one of the following entities:
a bank;
an owner of a card used to access the means of inputting;
a trusted third party; or
a manufacturer of the terminal.

10. A transaction method comprising:
acquisition by an electronic payment terminal of biometric data, during a transaction;
storage of the biometric data in the payment terminal; and
validation of the transaction irrespectively of the stored biometric data.

11. The transaction method according to claim 10, and further comprising implementing the method with an electronic payment terminal comprising:
a biometric data acquisition device,
a device for inputting a code by a user, and
a program capable of:
acquiring the biometric data during the transaction, by the biometric data acquisition device; and
storing the biometric data in the payment terminal, the electronic payment terminal being capable of validating the transaction irrespectively of the stored biometric data and said program being configured such that, for the user, said biometric data acquisition device validates the inputting of said code.
